(19) United States
(12) Patent Application Publication
(10) Pub. No.: US 2025/0306052 A1
(43) Pub. Date: Oct. 2, 2025

(54) APPARATUS AND METHOD FOR TRANSFERRING AND DELIVERING DRIED REAGENTS

(71) Applicant: ILLUMINA, INC., San Diego, CA (US)

(72) Inventors: Dorry Poa, Singapore (SG); Yin Nah Teo, Singapore (SG); Mikko Ponkala, San Francisco, CA (US); Paul Limb, San Mateo, CA (US); Sherman Lauw, Singapore (SG)

(21) Appl. No.: 18/851,610

(22) PCT Filed: Dec. 14, 2023
(86) PCT No.: PCT/US23/83957

§ 371 Date: Sep. 26, 2024

Related U.S. Application Data
(60) Provisional application No. 63/435,017, filed on Dec. 23, 2022.

(51) Int. Cl. G01N 35/10; B01L 3/00

(52) U.S. Cl. CPC G01N 35/1002; B01L 3/50853; G01N 35/1011; G01N 35/1016; G01N 35/1079; B01L 2300/044; B01L 2300/0829

(57) ABSTRACT

Apparatus and methods for transferring and delivering dried reagents are disclosed. In accordance with an implementation, an apparatus includes a carrier comprising a carrier body and a plurality of pins extending from the carrier body. The pins are aligned and oriented to correspond to a plurality of wells in a well plate. Each of the plurality of pins has an end surface, opposite the carrier body and a dried reagent is retained on the end surface of at least a portion of the plurality of pins.

### RELATED APPLICATION

This application claims the benefit of and priority to U.S. Provisional Patent Application No. 63/435,017, filed Dec. 23, 2022, the content of which is incorporated by reference herein in its entirety and for all purposes.

### BACKGROUND

Handling and delivery of small volumes of liquid reagents can be a challenge in manufacturing, instrumentation, and experimental workflows. For example, there are larger variations when working with small volumes, expensive instrumentation may be required for accurate dispensing, overfill can be required to accommodate small volume aspiration, there is a high consumable usage (plastic), etc. Moreover, current library preparation platforms such as liquid handlers are not optimized for small volume delivery while maintaining small dead volume.

### SUMMARY

Advantages and benefits over the prior art as described later in this disclosure can be achieved through the provision of apparatus and methods for transferring and delivering dried reagents. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus comprises a carrier having a carrier body and a plurality of pins extending from the carrier body. The plurality of pins are aligned and oriented to correspond to a plurality of wells in a well plate and each of the plurality of pins has an end surface, opposite the carrier body. A dried reagent is retained on the end surface of at least one of the plurality of pins.

In accordance with a second implementation, an apparatus comprises a carrier having a carrier body and a plurality of hollow pins extending from the carrier body. The plurality of hollow pins are aligned and oriented to correspond to a plurality of wells in a well plate and each of the plurality of hollow pins has an aperture that extends through the hollow pin and carrier body and a flexible membrane extending across an end of each hollow pin. A plunger includes a plunger body and a plurality of pins extending from the plunger body. The plurality of pins are aligned and oriented such that each of the plurality of pins is received within the aperture of a corresponding hollow pin of the plurality of hollow pins and each of the plurality of pins has an end surface, opposite the plunger body. A dried reagent is retained on the flexible membrane of at least a portion of the plurality of hollow pins.

In accordance with a third implementation, an apparatus comprises a carrier comprising a plurality of pins, each having an end surface; and a dried reagent retained on each end surface of each of the plurality of pins.

In accordance with a fourth implementation, a method comprises: disposing a liquid reagent on an end surface of at least one of a plurality of pins, where a carrier comprises the plurality of pins, the plurality of pins aligned and oriented to correspond to a plurality of wells in a well plate; and drying the liquid reagent such that the dried reagent is retained on the end surfaces of the pins.

In accordance with a fifth implementation, a method comprises: disposing a liquid reagent on a flexible membrane of at least one of a plurality of hollow pins, where a carrier comprises the plurality of hollow pins, the plurality of hollow pins aligned and oriented to correspond to a plurality of wells in a well plate, where each of the plurality of hollow pins have an aperture that extends through the hollow pin and the carrier, where a flexible membrane extends across an end of each of the plurality of hollow pins; and drying the liquid reagent such that the dried reagent is retained on the flexible membrane of the plurality of hollow pins.

In accordance with a sixth implementation, an apparatus comprises a pipette and a solid, dried reagent positioned within the pipette.

In accordance with a seventh implementation, a method comprises: aspirating a reagent in liquid form into a pipette and drying the reagent within the pipette such that the dried reagent is retained within the pipette.

In accordance with an eighth implementation, a method comprises: removing a cap from a plurality of pins, where a carrier comprises the plurality of pins and a dried reagent is retained on an end surface of at least one of the plurality of pins, the plurality of pins aligned and oriented to correspond to a plurality of wells in a well plate; and rehydrating the dried reagent.

In accordance with a ninth implementation, a method comprises: extending a plurality of pins through a pierceable membrane of a cap and into a plurality of wells in a well plate, where a carrier comprises the plurality of pins and a dried reagent is retained on an end surface of at least one of the plurality of pins, the plurality of pins aligned and oriented to correspond to the plurality of wells in the well plate; and rehydrating the dried reagent.

In accordance with a tenth implementation, a method comprises: extending a plurality of hollow pins through a pierceable membrane of a cap and into a plurality of well in a well plate, where a carrier comprises the plurality of pins and a dried reagent is retained on a flexible membrane secured to an end of at least one of the plurality of hollow pins, the plurality of hollow pins aligned and oriented to correspond to the plurality of wells in the well plate; extending a plurality of pins through the plurality of hollow pins of the carrier to deform the flexible membrane and push the dried reagents out of the plurality of hollow pins, where a plunger comprises the plurality of pins, the plurality of pins of the plunger aligned and oriented to correspond to the plurality of hollow pins of the carrier; and rehydrating the dried reagent.

In further accordance with the foregoing first, second, third, fourth, fifth, sixth, seventh, eighth, ninth, and/or tenth implementations, an apparatus and/or method may further include or comprise any one or more of the following:

In an implementation, the pins are generally cylindrical.

In another implementation, the end surfaces of the pins are planar surfaces.

In another implementation, the end surfaces of the pins are concave surfaces.

In another implementation, the end surfaces of the pins have a first slot extending radially across the end surface.

In another implementation, the end surfaces of the pins have a second slot extending radially across the end surface, generally perpendicular to the first slot.

In another implementation, the end surfaces of the pins comprise outwardly extending cups, each cup having a corresponding concave cavity.

In another implementation, the apparatus includes a cap comprising a cap body and a plurality of covers extending from the cap body, each of the plurality of covers including a cavity configured to receive a corresponding pin of the carrier.

In another implementation, the plurality of covers are snap fit to the plurality of pins.

In another implementation, the cap comprises a plurality of key features extending from the cap body, opposite the covers, each of the plurality of key feature being configured to be engaged by a cap removal system.

In another implementation, each of the plurality of key features comprises a shaft and a head at the end of the shaft, the head having a larger diameter than the shaft.

In another implementation, the apparatus includes a cap, the cap comprising: a cap body; a plurality of covers extending from the cap body, each of the plurality of covers comprising an aperture that extends through the cover and the cap body and is configured to receive a corresponding pin of the carrier; and at least one pierceable membrane secured to the cap body and sealing at least a portion of the apertures.

In another implementation, each of the plurality of pins includes a membrane piercing member extending from the end surface.

In another implementation, the plurality of pins comprise a first pin having a first reagent retained on the end surface of the first pin and a second pin having a second reagent, different than the first reagent, retained on the end surface of the second pin.

In another implementation, the end surfaces of the pins have a protruding surface.

In another implementation, the apparatus includes a cap, the cap comprising: a cap body; a plurality of covers extending from the cap body, each of the plurality of covers comprising an aperture that extends through the cover and the cap body and is configured to receive a corresponding hollow pin of the carrier; and at least one pierceable membrane secured to the cap body and sealing at least a portion of the apertures.

In another implementation, about 5 μL of liquid reagent is disposed on the end surface of at least a portion of the plurality of pins.

In another implementation, drying the liquid reagent comprises lyophilizing the liquid reagent on the plurality of pins.

In another implementation, drying the liquid reagent comprises oven drying the liquid reagent on the plurality of pins.

In another implementation, the method includes removably securing a cap onto the carrier such that the dried reagent on the end surfaces of each of the plurality of pins is disposed within a corresponding cavity of a plurality of cavities formed in the cap.

In another implementation, the cap is snap fit to the carrier.

In another implementation, the method includes removing the cap and rehydrating the dried reagent on the end surfaces of each of the plurality of pins.

In another implementation, the method includes providing a plunger comprising a plurality of pins, the plurality of pins aligned and oriented such that each of the plurality of pins is received within the aperture of a corresponding hollow pin of the plurality of hollow pins; and inserting the plurality of pins of the plunger into corresponding hollow pins of the carrier.

In another implementation, the method includes removing the cap and rehydrating the dried reagent on the flexible membranes of each of the plurality of hollow pins.

In another implementation, rehydrating the dried reagent comprises inserting the plurality of pins into the corresponding plurality of wells of the well plate, the plurality of wells having a liquid therein, and waiting a period of time.

In another implementation, the method includes agitating the plurality of pins within the plurality of wells for a period of time.

In another implementation, rehydrating the dried reagent comprises inserting the plurality of pins into the corresponding plurality of wells of the well plate, dispensing a liquid into the plurality of wells, and waiting a period of time.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a perspective view of a first implementation of an apparatus for transfer and delivery of a dried reagent;

FIGS. 2A-2D illustrates perspective views of various end surface designs that can be used in the apparatus of FIG. 1;

FIG. 3 illustrates a perspective view of the apparatus of FIG. 1 with 96 pins having the end surface design shown in FIG. 2C;

FIG. 4A illustrates a perspective view of a second implementation of an apparatus for transfer and delivery of a dried reagent;

FIG. 4B illustrates a cross-section of a portion of the apparatus of FIG. 4;

FIG. 5 illustrates a top view of a cap removal system that can be used with the apparatus of FIG. 4A;

FIG. 6 illustrates a perspective view of a third implementation of an apparatus for transfer and delivery of a dried reagent;

FIG. 7A illustrates a cross-section of a portion of the apparatus of FIG. 6 in a first position;

FIG. 7B illustrates a cross-section of a portion of the apparatus of FIG. 6 in a second position;

FIG. 8 illustrates a perspective view of a fourth implementation of an apparatus for transfer and delivery of a dried reagent;

FIG. 9 illustrates a perspective view of a fifth implementation of an apparatus for transfer and delivery of a dried reagent;

FIG. 10A illustrates a cross-section of a portion of the apparatus of FIG. 9 in a first position;

FIG. 10B illustrates a cross-section of a portion of the apparatus of FIG. 9 in a second position;

FIG. 10C illustrates a cross-section of a portion of the apparatus of FIG. 9 in a third position;

FIG. 11A illustrates a side view of a sixth implementation of an apparatus for transfer and delivery of a dried reagent with the dried reagent in a first position;

FIG. 11B illustrates the apparatus of FIG. 11A with the dried reagent in a second position;

FIG. 12 illustrates a flow chart representing a first implementation of a method for transferring and delivering a dried reagent;

FIG. 13 illustrates a flow chart representing additional processes that can be used with the method of FIG. 12;

FIG. 14 illustrates a flow chart representing additional processes that can be used with the method of FIG. 12;

FIG. 15 illustrates a flow chart representing a second implementation of a method for transferring and delivering a dried reagent;

FIG. 16 illustrates a flow chart representing additional processes that can be used with the method of FIG. 15;

FIG. 17 illustrates a flow chart representing a third implementation of a method for transferring and delivering a dried reagent; and

FIG. 18 illustrates a well and well plate that can be used with the apparatus and methods of FIG. 1-15.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

In many processes, reagents are used in very small volumes of microliters or less. In these instances, the ability to transfer and deliver small volumes of dried reagents, rather than reagents in liquid form, can provide a variety of benefits. For example, the transfer and delivery of dried reagents can reduce the need for high consumable (plastic) usage, such as pipette tips and well plates. For instance, if the reagents are stored in a single tube, but dispensed into the reaction wells simultaneously using a multi-pipette head that can access each reaction well simultaneously the reagent is usually first pipetted from the single storage tube into an intermediary well plate to be accessible by the multi-pipette head. Such transfer processes result in plastic waste in addition to just the pipette tips.

In addition, the ability to transfer and deliver dried reagents can reduce or eliminate the need for expensive liquid handling instruments that pose as a high barrier of entry (cost and space) and can reduce or eliminate the need for precise fluid contact operations.

The ability to transfer and deliver dried reagents can also provide other potential benefits, such as reducing dead volume needed in traditional pipetting, reducing overfill and sample loss, reducing cost of goods sold, and enabling automation.

At least one aspect of this disclosure is directed toward apparatus and methods for transferring and delivering small volumes of reagent, which can allow small reagent volumes to be delivered simultaneously into multiple wells of a typical microtiter plate with minimal or without any dead volume requirement for reagent fill.

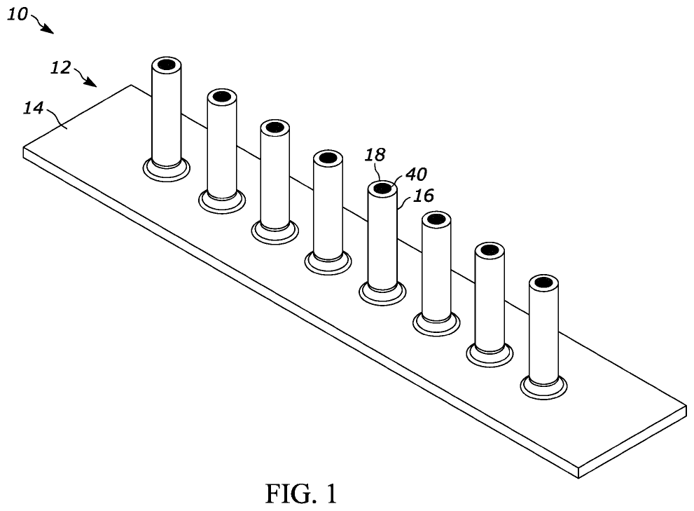

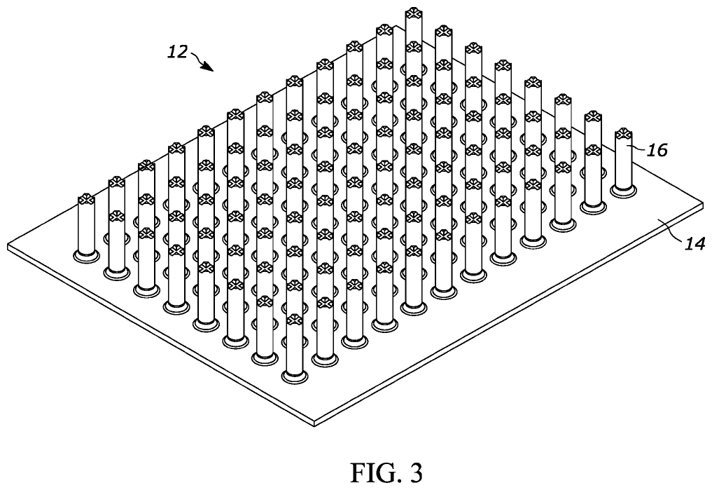

FIGS. 1-3 illustrate a first implementation of an apparatus 10 that can be used for the transfer and delivery of small volumes of reagents. In this implementation, apparatus 10 includes a carrier 12 having a carrier body 14, shown as a generally planar plate, and a plurality of pins 16 extending from carrier body 14. In the implementation show, apparatus 10 includes eight pins 16, which are aligned in a single row along a longitudinal axis of carrier body 14 and are aligned and oriented to correspond to a plurality of wells 52 in a well plate 50 (see FIG. 18). However, carrier 12 can have any number of pins 16 arranged in any number of rows. For example, carrier 12 could have ninety-six pins 16 that are arranged in twelve rows of eight pins (FIG. 3). Each pin 16 has an end surface 18, opposite carrier body 14, and a dried reagent 40 is retained on end surface 18 of at least a portion (e.g., one or more) of pins 16. Dried reagent 40 may be the same reagent on the end surface 18 of each of the pins 16 in some implementations. Alternatively, dried reagent 40 may be a different reagent on the end surface 18 of at least the portion of two of the pins 16 in other implementations. One or more of the pins 16 may thus carry different dried reagent 40 as compared to another one or more of the pins 16. For example, a first set of pins 16 may carry a first dried reagent, and a second set of pins 16 may carry a second dried reagent, where the first dried reagent is different than that second dried reagent. As an additional example, a first set of pins 16 may carry a first dried reagent, and a second set of pins may carry a second dried reagent, and a third set of pins 16 may carry a third dried reagent, where the first dried reagent is different than the second dried reagent and third dried reagent, and where the second dried reagent is different that the third dried reagent.

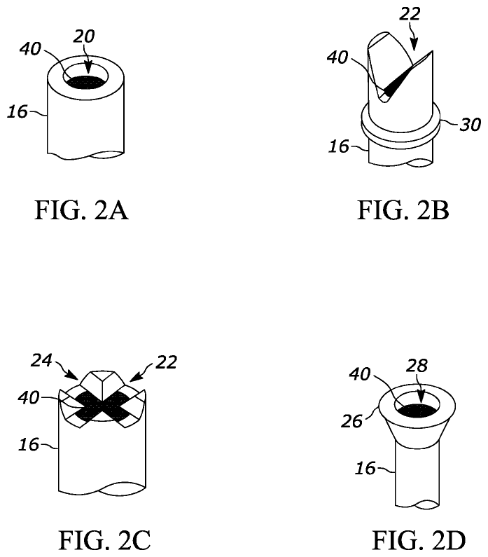

Pins 16 can be generally cylindrical and, as shown in FIG. 1, end surfaces 18 of pins 16 can be a generally planar surfaces. As shown in FIGS. 2A-D, rather than a generally planar surface, end surfaces 18 of pins 16 can also have other configurations. For example, end surfaces 18 can have a concave surface 20, with dried reagent 40 retained in a cavity formed by concave surface 20 (FIG. 2A). End surfaces 18 can have a first slot 22 extending radially across end surface 18, with dried reagent 40 retained in a cavity formed by first slot 22 (FIG. 2B). End surfaces 18 can have first slot 22 and a second slot 24 extending radially across end surface 18, generally perpendicular to first slot 22, with dried reagent 40 retained in cavities formed by first slot 22 and second slot 24 (FIG. 2C). End surfaces 18 can have a cup 26 having a concave cavity 28, with dried reagent 40 retained in concave cavity 28. End surfaces 18 generally can have any other configuration that would allow the dried reagent to be retained on the end surface of the pins and be rehydrated efficiently.

While at least some implementations herein describe the pins 16 as generally cylindrical in shape, other shapes may be implemented, such as conical, square, pyramid, or squircle. For example, each pin may be generally conical with the end surface being a frustum of the cone to support the dried reagent.

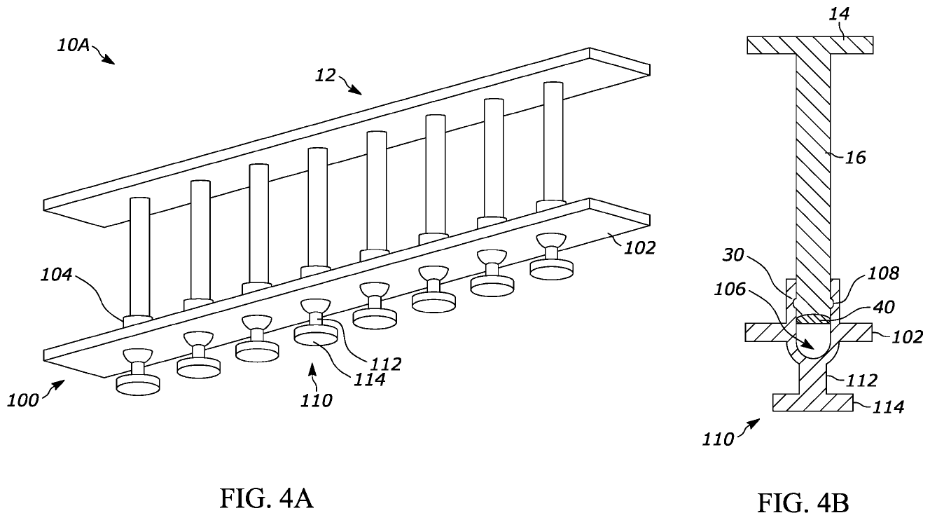

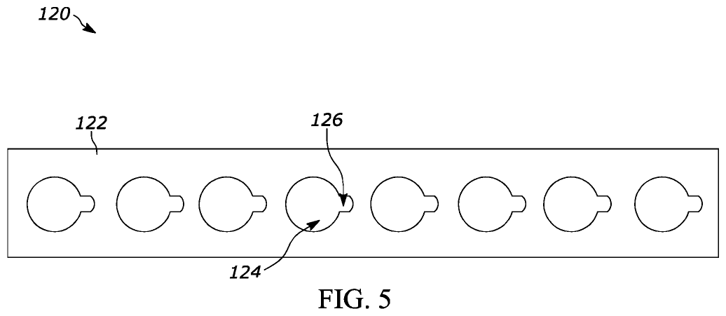

Dried reagent 40 on pins 16 can also be protected from the environment during storage, transfer, and delivery of apparatus 10. FIGS. 4A-B illustrate a second implementation of an apparatus 10A that includes carrier 12 and a cap 100, which provides protection for dried reagent 40 during storage, transfer, and delivery. In the implementation shown, cap 100 includes a cap body 102, shown as a generally planar plate, and a plurality of covers 104 extending from a surface of cap body 102. The number, alignment, and orientation of covers 104 corresponds to the number, alignment, and orientation of pins 16 and each cover 104 includes a cavity 106 that is configured to receive a corresponding pin 16. In the implementation shown, cap 100 includes eight covers 104, which, like corresponding pins 16, are aligned in a single row along a longitudinal axis of cap body 102. However, cap 100 can have any number of covers 104 arranged in any number of rows. For example, like pins 16 of carrier 12, cap 100 could have ninety six covers 104 that are arranged in twelve rows of eight covers.

To retain cap 100 on carrier 12, covers 104 are configured to snap fit to corresponding pins 16, such as through an annular protrusion 30 formed around each pin 16 engaging an annular groove 108 formed within each cavity 106 of each cover 104. A snap-fit connection may thus be formed between the cap 100 and the cover 104. This allows cap 100 to be easily secured to and removed from carrier 12 by manual or automated means.

To assist in removal of cap 100 from carrier 12, cap 100 can have a plurality of key features 110 that extend from cap body 102, opposite covers 104, and that are configured to be engaged by a manual or automated cap removal system 120 (FIG. 5). As shown, each key feature 110 can include a shaft 112 that extends from cap body 102 and a head 114 and an end of shaft 112, opposite cap body 102, that has a diameter that is larger than the diameter of shaft 112. With this configuration, as shown in FIG. 5, cap removal system 120 can have a mating locking geometry and can be used manually or by an automated system. In the implementation shown, cap removal system 120 can include a system body 122, shown as a generally planar plate in the implementation shown, having a plurality of holes 124 to receive heads 114 therethrough and a corresponding slot 126 extending from each hole 124 to receive shafts 112. Heads 114 of key features 110 can be inserted through holes 124 and system body 122 can be moved laterally such that shafts 112 engage slots 126. Carrier 12 can them be pulled away from cap removal system 120, which will remove cap 100 from carrier 12.

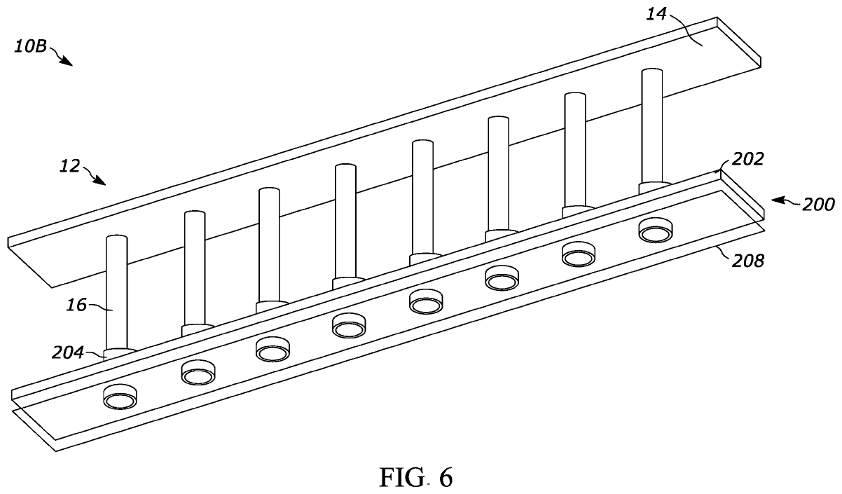

FIG. 6 illustrates a third implementation of an apparatus 10B that includes carrier 12 and a cap 200, which provides protection from the environment for dried reagent 40 during storage, transfer, and delivery. In the implementation shown, cap 200 includes a cap body 202, shown as a generally planar plate, and a plurality of covers 204 extending from a surface of cap body 202. The number, alignment, and orientation of covers 204 corresponds to the number, alignment, and orientation of pins 16. Each cover 204 includes an aperture 206 that extends through cover 204 and cap body 202. Each aperture 206 is configured to receive a corresponding pin 16. In the implementation shown, cap 200 includes eight covers 204, which, like corresponding pins 16, are aligned in a single row along a longitudinal axis of cap body 202. However, cap 200 can have any number of covers 204 arranged in any number of rows. For example, like pins 16 of carrier 12, cap 200 could have ninety-six covers 204 that are arranged in twelve rows of eight covers.

Cap 200 also includes a pierceable membrane 208 that is secured to a top surface of cap body 202, opposite covers 204, to seal at least a portion (e.g., one or more) of apertures 206. As shown, membrane 208 is a single membrane that covers all apertures 206. However, there could also be a separate membrane that covers each aperture, a single membrane that only covers a certain number of apertures, etc.

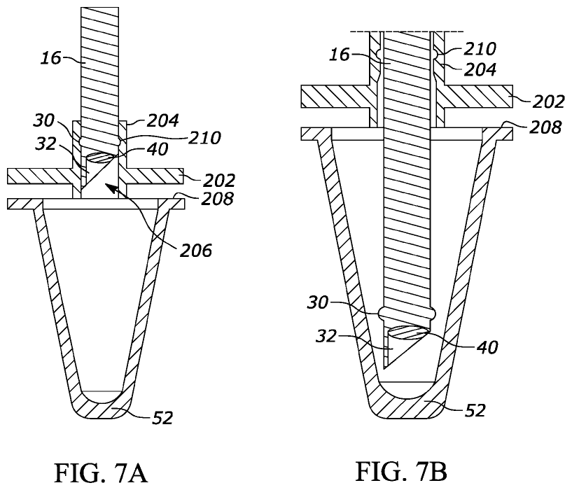

To retain cap 200 on carrier 12, covers 204 are configured to snap fit to corresponding pins 16, such as through annular protrusion 30 formed around each pin 16 engaging an annular groove 210 formed within each aperture 206 of each cover 204. This allows cap 200 to be easily secured to carrier 12 and for dried reagent 40 to be easily delivered from apparatus 10B. As can be seen in FIG. 7A, when assembled, dried reagent 40 is protected by the sides of covers 204 and membrane 208.

In apparatus 10B, pins 16 of carrier 12 can each also include a membrane piercing member 32, such as a sharp or pointed geometry or protruding element, that extends from end surfaces 18 and can be used to pierce membrane 208 to deliver dried reagent 40. As discussed in more detail below, to deliver dried reagent 40, carrier body 14 of carrier 12 can be moved towards cap 200 until the snap fit between carrier 12 and cap 200 is overcome. By continuing movement of carrier body 14 towards cap 200, membrane piercing member 32 can then pierce membrane 208 an end surfaces 18 of pins 16, and therefore dried reagent 40, will extend past the membrane 208 and past the end of covers 204 for delivery (see FIG. 7B).

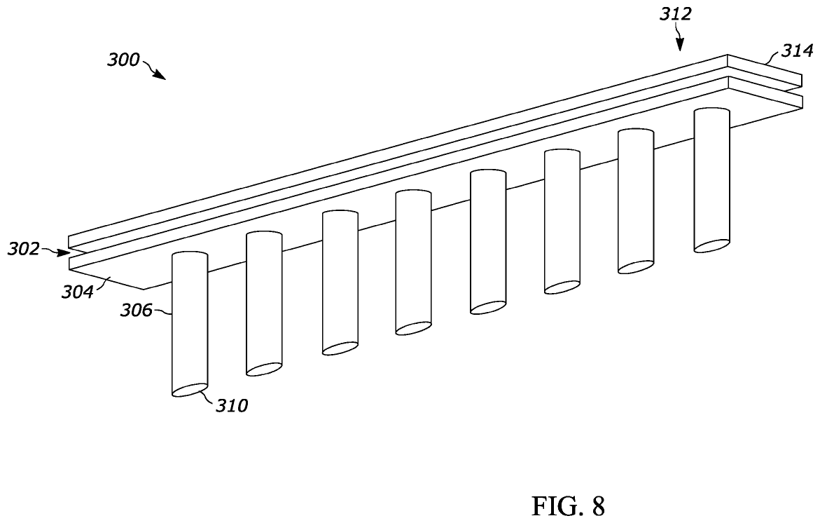

FIG. 8 illustrates a fourth implementation of an apparatus 300 that can be used for the transfer and delivery of small volumes of reagents. In this implementation, apparatus 300 includes a carrier 302 that has a carrier body 304, shown as a generally planar plate, with a plurality of hollow pins 306 extending from carrier body 304. In the implementation show, apparatus 300 includes eight hollow pins 306, which are aligned in a single row along a longitudinal axis of carrier body 304 and are aligned and oriented to correspond to wells 52 in well plate 50 and eight corresponding pins 316. However, carrier 302 can have any number of hollow pins 306 and pins 316 arranged in any number of rows. For example, carrier 302 could have ninety-six hollow pins 306 that are arranged in twelve rows of eight pins. Each hollow pin 306 includes an aperture 308 that extends through hollow pin 306 and carrier body 304 and a flexible membrane 310 extending across the end of each hollow pin. A dried reagent 330 is retained on the flexible membrane of at least a portion (e.g., one or more) of hollow pins 306.

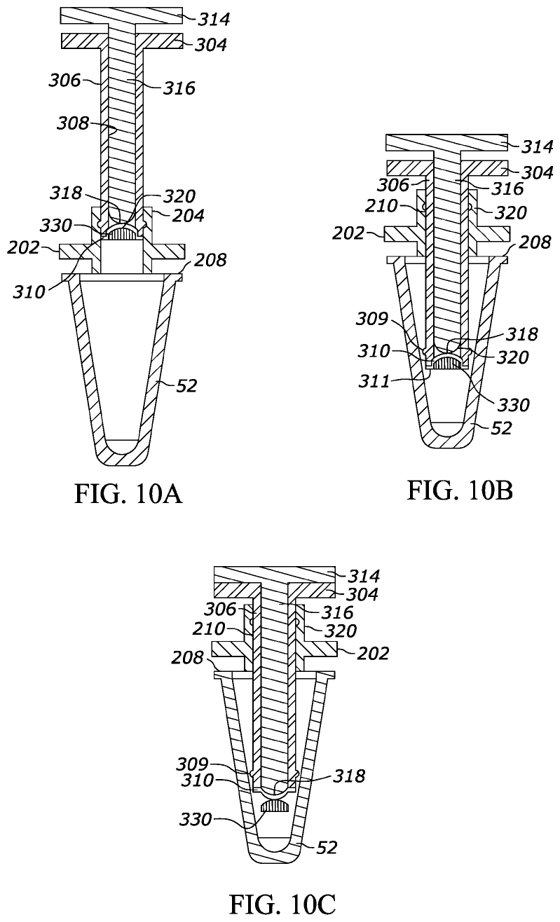

A plunger 312 has a plunger body 314, shown as a generally planar plate, having a plurality of pins 316 (see, e.g., FIG. 10A) that extend from plunger body 314 and are aligned and oriented such that each pin 316 is received within aperture 308 of a corresponding hollow pin 306. Each pin 316 has an end surface 318, opposite plunger body 314.

As described above for pins 16, pins 316 can be generally cylindrical. End surfaces 318 of pins 316 can be also have a protruding surface to assist in pushing flexible membrane 310 and extending dried reagent 330 away from hollow pins 306 when rehydrating dried reagent.

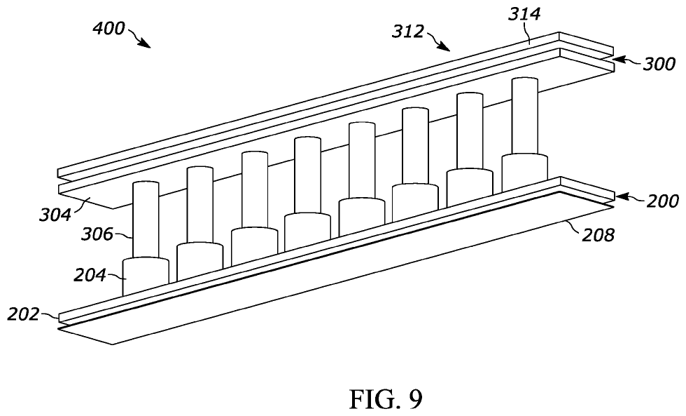

FIGS. 9-10 illustrates a fifth implementation of an apparatus 400 that includes apparatus 300 and cap 200, which provides protection from the environment for dried reagent 330 during storage, transfer, and delivery. To retain cap 200 on apparatus 300, covers 204 are configured to snap fit to corresponding hollow pins 306, such as through annular protrusion 309 formed around each hollow pin 306 engaging annular groove 210 of each cover 204. This allows cap 200 to be easily secured to apparatus 300 and for dried reagent 330 to be easily delivered from apparatus 400. As can be seen in FIG. 10A, when assembled, dried reagent 330 is protected by the sides of covers 204 and membrane 208.

As discussed in more detail below, to deliver dried reagent 330, apparatus 300 can be moved towards cap 200 until the snap fit between apparatus 300 and cap 200 is overcome. By continuing movement of apparatus 300 towards cap 200, membrane piercing member 311 can then pierce membrane 208 and hollow pins 306 will extend past the membrane 208 and past the end of covers 204 (see FIG. 10B). Plunger body 314 can then be moved towards carrier body 304, which will push flexible membrane 310 and dried reagent 330 out of hollow pin 306 to deliver dried reagent 330 (see FIG. 10C).

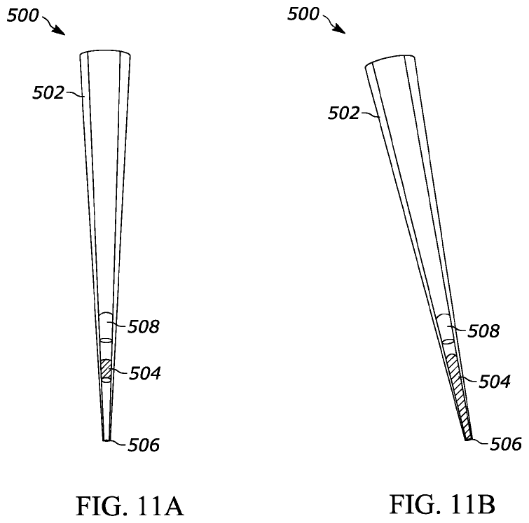

FIGS. 11A-B illustrate a sixth implementation of an apparatus 500 that can be used for the transfer and delivery of small volumes of reagents. In this implementation, apparatus 500 includes a pipette 502 and a solid, dried reagent 504 positioned within pipette 502. As shown in FIG. 11A, dried reagent 504 can be spaced from an end 506 of pipette 502 and from a filter insert 508 positioned within pipette 502 or dried reagent 504 can be positioned at the end 506 of pipette 502 and spaced apart from filter insert 508.

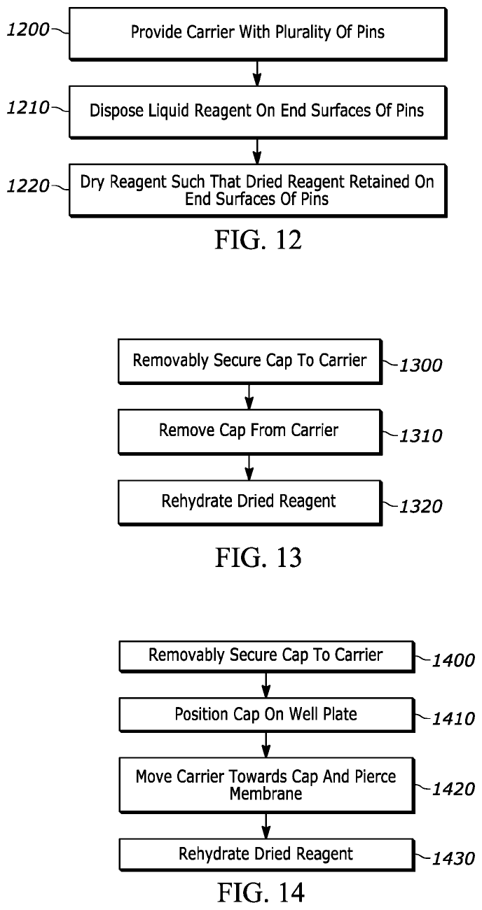

Referring to FIG. 12, a first implementation of a method for transferring and delivering reagents, using the apparatus shown in FIGS. 1-7 and described above, is illustrated. In this implementation, at Block 1200, a carrier is provided that includes a plurality of pins that are aligned and oriented to correspond to a plurality of wells in a well plate. A liquid reagent, for example about 5 μL of liquid reagent, is then disposed on an end surface of at least a portion (e.g., at least one) of the plurality of pins at Block 1210. At Block 1220, the liquid reagent is then dried, for example via lyophilization or oven drying, such that the dried reagent is retained on the end surface(s) of the pin(s). In general, oven drying of the reagent can take less time and can be easier than lyophilization of the reagent, however, the rehydration speed of oven dried reagent can take longer than for lyophilized reagent. Furthermore, some reagents may tolerate lyophilization more than oven drying, while other reagents may tolerate oven drying as much or more than lyophilization. In some implementations, about 5 μL of liquid reagent is disposed on the end surface. In other implementations, other volumes of liquid reagent may be disposed on the end surface, such as between about 3 μL to 7 μL, or 1 μL to 10 μL, or less than 15 μL. Other volumes of liquid reagent may be suitable.

As illustrated in FIG. 13, to continue the transfer and delivery of the reagent using the apparatus shown in FIGS. 4-5 and described above, at Block 1300, the cap can be removably secured onto the carrier, for example via a snap fit between the pins of the carrier and the covers of the cap, such that the dried reagent on the end surfaces of each of the pins is disposed within a corresponding cavity of a corresponding cup. The assembled cap and carrier can also be stored and shipped in a dry moisture proof envelope, such as a heat-sealed bag or blister pack. When the reagent is ready for use, at Block 1310, the cap can be removed from the carrier to expose the dried reagent on the ends of the pins. As discussed above, this can be done by engaging the key features on the cap with the cap removal system and pulling the carrier from the cap while the cap is held in place by the cap removal system. At Block 1320, the dried reagent on the end surfaces of the pins can then be rehydrated, for example by inserting the pins of the carrier into corresponding wells of a well plate that each contain a reaction solution. In this method, the amount of wasted/discarded reagent could be kept to a minimum as, for example, there are little to no dead volumes involved with typical well-plates.

As illustrated in FIG. 14, to continue the transfer and delivery of the reagent using the apparatus shown in FIGS. 6-7B and described above, at Block 1400 the cap can be removably secured onto the carrier, for example via a snap fit between the pins of the carrier and the covers of the cap, such that the dried reagent on the end surfaces of each of the pins is disposed within a corresponding cavity of a corresponding cup. The assembled cap and carrier can also be stored and shipped in a dry moisture proof envelope, such as a heat-sealed bag or blister pack. When the reagent is ready for use, at Block 1410, the cap can be positioned on the well plate such that each of the pins of the carrier is aligned with a corresponding well in the well plate. At Block 1420, the carrier is moved towards the cap until the snap fit between the carrier and the cap is overcome and the pin pierces and moves through the membrane and into the well of the well plate. At Block 1430, the dried reagent on the end surfaces of the pins can then be rehydrated in a reaction solution in each corresponding well of the well plate. In addition, in this method, the amount of wasted/discarded reagent could be kept to a minimum as, for example, there are little to no dead volumes involved with typical well-plates.

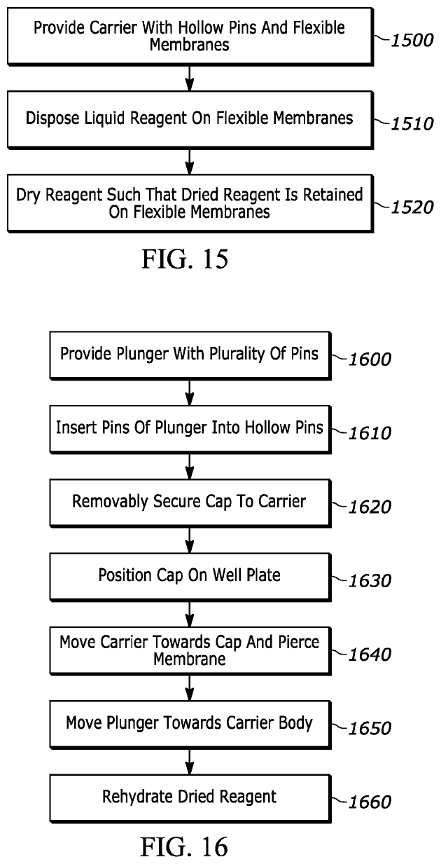

As illustrated in FIG. 15 a second implementation of a method for transferring and delivering reagents, using the apparatus shown in FIGS. 8-10 and described above, is illustrated. At Block 1500 a carrier is provided that includes a plurality of hollow pins. The plurality of hollow pins being aligned and oriented to correspond to a plurality of wells in a well plate and each of the plurality of hollow pins having an aperture that extends through the hollow pin and carrier body and a flexible membrane extending across an end of each hollow pin. At Block 1510 a liquid reagent is disposed on the flexible membrane of at least a portion (e.g., one of more) of the hollow pins and the liquid reagent is dried at Block 1520 such that the dried reagent is retained on the flexible membrane of the hollow pins. In some implementations, about 5 μL of liquid reagent is disposed on the flexible membrane. In other implementations, other volumes of liquid reagent may be disposed on the flexible membrane, such as between about 3 μL to 7 μL, or 1 μL to 10 μL, or less than 15 μL. Other volumes of liquid reagent may be suitable.

As illustrated in FIG. 16, to continue the transfer and delivery of the reagent using the apparatus shown in FIGS. 8-10 and described above, at Block 1600 a plunger is provided that comprises a plurality of pins. At Block 1610, the plurality of pins of the plunger are aligned and oriented such that each of the plurality of pins is received within the aperture of a corresponding hollow pin of the plurality of hollow pins and the plurality of pins are inserted into corresponding hollow pins of the carrier. At Block 1620, a cap can then be removably secured onto the carrier, for example, via a snap fit between the hollow pins and the covers of the cap, such that the dried reagent on the end surfaces of each of the pins is disposed within a corresponding cavity of a corresponding cup. The assembled cap and carrier can also be stored and shipped in a dry moisture proof envelope, such as a heat-sealed bag or blister pack. When the reagent is ready for use, at Block 1630, the cap can be positioned on the well plate. At Block 1640, the carrier and plunger are moved towards the cap until the snap fit between the hollow pins and the cap is overcome and the hollow pins pierce and move through the membrane of the cap and into the well of the well plate. The plunger is then moved towards the carrier body at Block 1650 to push the flexible membrane of the carrier and the dried reagent out of the hollow pins of the carrier. At Block 1660, the dried reagent on the flexible membranes can then be rehydrated in a reaction solution in each corresponding well of the well plate. Again, in this method, the amount of wasted/discarded reagent could be kept to a minimum as, for example, there are little to no dead volumes involved with typical well-plates.

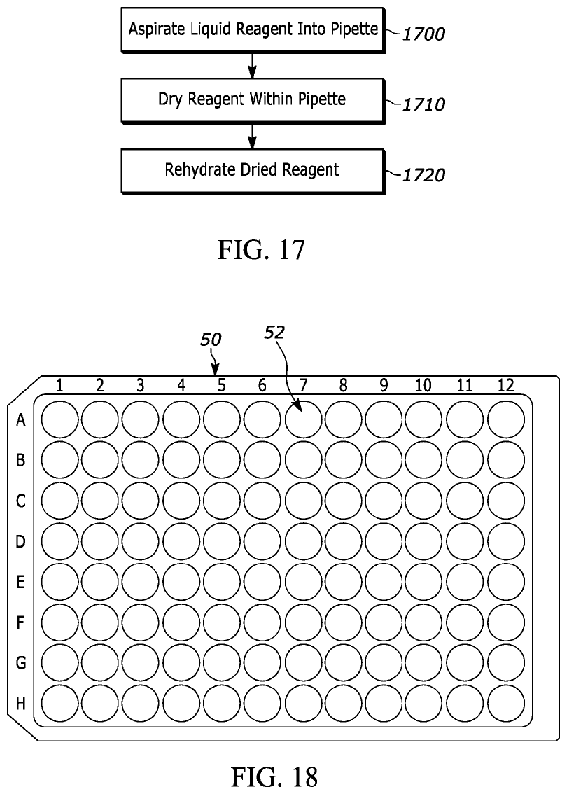

Referring to FIG. 17, a third implementation of a method for transferring and delivering dried reagents using the apparatus shown in FIGS. 11A-B and described above is illustrated. In this implementation, at Block 1700, a reagent in liquid form, for example from 5-12 μL, or from 1-15 μL, or less than 20 μL of the liquid reagent, is aspirated into the pipette. As discussed above, the liquid reagent could be aspirated into the pipette such that there are air gaps between the reagent and the end of the pipette and between the reagent and the filter insert or such that the liquid reagent is disposed at the end of the pipette and there is an air gap between the reagent and the filter insert. At Block 1710, the reagent is then dried within the pipette such that the reagent is retained within the pipette. The liquid reagent could be dried using any appropriate technique, such as lyophilization or oven drying. In general, oven drying of the reagent can take less time and can be easier than lyophilization of the reagent, however, the rehydration speed of oven dried reagent can take longer than for lyophilized reagent. The dried reagent could then be rehydrated at Block 1620 using the reaction solution in a well of a well plate, reducing or eliminating the need for intermediary plates for pipetting or reagent cartridges or tubes for on instrument deck storage.

In some implementations, the dried reagent is rehydrated by inserting the pins of the carrier into corresponding wells of a well plate having a liquid therein, and waiting a period of time, such as 1 second, 5 seconds, 10 seconds, etc. In some implementations, the dried reagent is rehydrated by inserting the pins of the carrier into corresponding wells of a well plate and then dispensing a liquid into the well, and waiting a period of time, such as 1 second, 5 seconds, 10 seconds, etc. In some implementations, the dried reagent is rehydrated by inserting the pins of the carrier into corresponding wells of a well plate having a liquid therein and agitating the pins within the wells for a period of time, such as 1 second, 5 seconds, 10 seconds, etc.

After the dried reagent is rehydrated, the resulting reagent may be used, for example, as a part of a biological or chemical analysis, such as nucleic acid sample preparation and/or library preparation. For example, after rehydration, one or more samples of interest may be deposited into each of the wells of the well plate. In another example, the reagent is combined with one or more other reagents and/or buffers, before or after a sample of interest is deposited into the well. In another example, after the rehydrated reagent is combined with one or more of a sample of interest, reagent, buffer, library, or other substance, the resulting material is removed from the well, such as via aspiration. The resulting material may then be analyzed, for example, as a part of a sequencing by synthesis process, array-based assay, etc. Other biological or chemical analyses implementations may be suitable.

Example 1. An apparatus, comprising: a carrier comprising a carrier body and a plurality of pins extending from the carrier body, the plurality of pins aligned and oriented to correspond to a plurality of wells in a well plate and each of the plurality of pins having an end surface, opposite the carrier body; and a dried reagent retained on the end surface of at least one of the plurality of pins.

Example 2. The apparatus of example 1, wherein the pins are generally cylindrical.

Example 3. The apparatus of any one of examples 1-2, wherein the end surfaces of the pins are planar surfaces.

Example 4. The apparatus of any one of examples 1-2, wherein the end surfaces of the pins have a concave surface.

Example 5. The apparatus of any one of examples 1-2, wherein the end surfaces of the pins have a first slot extending radially across the end surface.

Example 6. The apparatus of example 5, wherein the end surfaces of the pins have a second slot extending radially across the end surface, generally perpendicular to the first slot.

Example 7. The apparatus of any one of examples 1-2, wherein the end surfaces of the pins comprise outwardly extending cups, each cup having a corresponding concave cavity.

Example 8. The apparatus of any one of examples 1-7, including a cap comprising a cap body and a plurality of covers extending from the cap body, each of the plurality of covers including a cavity configured to receive a corresponding pin of the carrier.

Example 9. The apparatus of example 8, wherein the plurality of covers are snap fit to the plurality of pins.

Example 10. The apparatus of any one of examples 8-9, wherein the cap comprises a plurality of key features extending from the cap body, opposite the covers, each of the plurality of key feature being configured to be engaged by a cap removal system.

Example 11. The apparatus of example 10, wherein each of the plurality of key features comprises a shaft and a head at an end of the shaft, the head having a larger diameter than the shaft.

Example 12. The apparatus of any one of examples 1-7, including a cap, the cap comprising: a cap body; a plurality of covers extending from the cap body, each of the plurality of covers comprising an aperture that extends through the cover and the cap body and is configured to receive a corresponding pin of the carrier; and at least one pierceable membrane secured to the cap body and sealing at least a portion of the apertures.

Example 13. The apparatus of example 12, wherein each of the plurality of pins includes a membrane piercing member extending from the end surface.

Example 14. The apparatus of any one of examples 1-13, wherein the plurality of pins comprise a first pin having a first reagent retained on the end surface of the first pin and a second pin having a second reagent, different than the first reagent, retained on the end surface of the second pin.

Example 15. An apparatus, comprising: a carrier comprising a carrier body and a plurality of hollow pins extending from the carrier body, the plurality of hollow pins aligned and oriented to correspond to a plurality of wells in a well plate and each of the plurality of hollow pins having an aperture that extends through the hollow pin and carrier body and a flexible membrane extending across an end of each hollow pin; and a plunger comprising a plunger body and a plurality of pins extending from the plunger body, the plurality of pins aligned and oriented such that each of the plurality of pins is received within the aperture of a corresponding hollow pin of the plurality of hollow pins and each of the plurality of pins having an end surface, opposite the plunger body; and a dried reagent retained on the flexible membrane of at least a portion of the plurality of hollow pins.

Example 16. The apparatus of example 15, wherein the pins are generally cylindrical.

Example 17. The apparatus of any one of examples 15-16, wherein the end surfaces of the pins have a protruding surface.

Example 18. The apparatus of any one of examples 15-17, including a cap, the cap comprising: a cap body; a plurality of covers extending from the cap body, each of the plurality of covers comprising an aperture that extends through the cover and the cap body and is configured to receive a corresponding hollow pin of the carrier; and at least one pierceable membrane secured to the cap body and sealing at least a portion of the apertures.

Example 19. A method, comprising: disposing a liquid reagent on an end surface of at least one of a plurality of pins, where a carrier comprises the plurality of pins, the plurality of pins aligned and oriented to correspond to a plurality of wells in a well plate; and drying the liquid reagent such that the dried reagent is retained on the end surfaces of the pins.

Example 20. The method of example 19, wherein about 5 μL of liquid reagent is disposed on the end surface of at least a portion of the plurality of pins.

Example 21. The method of any one of examples 19-20, wherein drying the liquid reagent comprises lyophilizing the liquid reagent on the plurality of pins.

Example 22. The method of any one of examples 19-20, wherein drying the liquid reagent comprises oven drying the liquid reagent on the plurality of pins.

Example 23. The method of any one of examples 19-22, further comprising:

removably securing a cap onto the carrier such that the dried reagent on the end surfaces of each of the plurality of pins is disposed within a corresponding cavity of a plurality of cavities formed in the cap.

Example 24. The method of example 23, wherein the cap is snap fit to the carrier.

Example 25. The method of any one of examples 23-24, further comprising removing the cap and rehydrating the dried reagent on the end surfaces of each of the plurality of pins.

Example 26. A method, comprising: disposing a liquid reagent on a flexible membrane of at least one of a plurality of hollow pins, where a carrier comprises the plurality of hollow pins, the plurality of hollow pins aligned and oriented to correspond to a plurality of wells in a well plate, where each of the plurality of hollow pins have an aperture that extends through the hollow pin and the carrier, where a flexible membrane extends across an end of each of the plurality of hollow pins; and drying the liquid reagent such that the dried reagent is retained on the flexible membrane of the plurality of hollow pins.

Example 27. The method of example 26, wherein about 5 μL of liquid reagent is disposed on the flexible membrane of at least a portion of the plurality of hollow pins.

Example 28. The method of any one of examples 26-27, wherein drying the liquid reagent comprises lyophilizing the liquid reagent on the flexible membrane of the plurality of hollow pins.

Example 29. The method of any one of examples 26-27, wherein drying the liquid reagent comprises oven drying the liquid reagent on the flexible membrane of the plurality of hollow pins.

Example 30. The method of any one of examples 26-29, further comprising: inserting a plurality of pins into corresponding hollow pins of the hollow pins of the carrier, where a plunger comprises the plurality of pins, the plurality of pins aligned and oriented such that each of the plurality of pins is received within the aperture of a corresponding hollow pin of the plurality of hollow pins.

Example 31. The method of example 30, further comprising:

removably securing a cap onto the carrier such that the dried reagent on the flexible membrane of each of the plurality of hollow pins is disposed within a corresponding cavity of a plurality of cavities formed in the cap.

Example 32. The method of example 31, wherein the cap is snap fit to the carrier.

Example 33. The method of any one of examples 31-32, comprising removing the cap and rehydrating the dried reagent on the flexible membranes of each of the plurality of hollow pins.

Example 34. An apparatus, comprising: a pipette; and a solid, dried reagent positioned within the pipette.

Example 35. A method, comprising: aspirating a reagent in liquid form into a pipette; and drying the reagent within the pipette such that the dried reagent is retained within the pipette.

Example 36. An apparatus, comprising: a carrier comprising a plurality of pins, each having an end surface; and dried reagent retained on the end surfaces of the plurality of pins.

Example 37. A method, comprising: removing a cap from a plurality of pins, where a carrier comprises the plurality of pins and a dried reagent is retained on an end surface of at least one of the plurality of pins, the plurality of pins aligned and oriented to correspond to a plurality of wells in a well plate; and rehydrating the dried reagent.

Example 38. A method, comprising: extending a plurality of pins through a pierceable membrane of a cap and into a plurality of wells in a well plate, where a carrier comprises the plurality of pins and a dried reagent is retained on an end surface of at least one of the plurality of pins, the plurality of pins aligned and oriented to correspond to the plurality of wells in the well plate; and rehydrating the dried reagent.

Example 39. A method, comprising: extending a plurality of hollow pins through a pierceable membrane of a cap and into a plurality of well in a well plate, where a carrier comprises the plurality of pins and a dried reagent is retained on a flexible membrane secured to an end of at least one of the plurality of hollow pins, the plurality of hollow pins aligned and oriented to correspond to the plurality of wells in the well plate; extending a plurality of pins through the plurality of hollow pins of the carrier to deform the flexible membrane and push the dried reagents out of the plurality of hollow pins, where a plunger comprises the plurality of pins, the plurality of pins of the plunger aligned and oriented to correspond to the plurality of hollow pins of the carrier; and rehydrating the dried reagent.

Example 40. The method of any one of examples 37-39, wherein rehydrating the dried reagent comprises inserting the plurality of pins into the corresponding plurality of wells of the well plate, the plurality of wells having a liquid therein, and waiting a period of time.

Example 41. The method of example 40, further comprising agitating the plurality of pins within the plurality of wells for a period of time.

Example 42. The method of any one of examples 37-39, wherein rehydrating the dried reagent comprises inserting the plurality of pins into the corresponding plurality of wells of the well plate, dispensing a liquid into the plurality of wells, and waiting a period of time.

Example 43. The apparatus of example 1, including a cap comprising a cap body and a plurality of covers extending from the cap body, each of the plurality of covers including a cavity configured to receive a corresponding pin of the carrier.

Example 44. The apparatus of example 43, wherein the plurality of covers are snap fit to the plurality of pins.

Example 45. The apparatus of example 43, wherein the cap comprises a plurality of key features extending from the cap body, opposite the covers, each of the plurality of key feature being configured to be engaged by a cap removal system.

Example 46. The apparatus of example 45, wherein each of the plurality of key features comprises a shaft and a head at an end of the shaft, the head having a larger diameter than the shaft.

Example 47. The apparatus of example 1, including a cap, the cap comprising: a cap body; a plurality of covers extending from the cap body, each of the plurality of covers comprising an aperture that extends through the cover and the cap body and is configured to receive a corresponding pin of the carrier; and at least one pierceable membrane secured to the cap body and sealing at least a portion of the apertures.

Example 48. The apparatus of example 47, wherein each of the plurality of pins includes a membrane piercing member extending from the end surface.

Example 49. The apparatus of example 15, including a cap, the cap comprising: a cap body; a plurality of covers extending from the cap body, each of the plurality of covers comprising an aperture that extends through the cover and the cap body and is configured to receive a corresponding hollow pin of the carrier; and at least one pierceable membrane secured to the cap body and sealing at least a portion of the apertures.

Example 50. The method of example 26, further comprising:
inserting a plurality of pins into corresponding hollow pins of the hollow pins of the carrier, where a plunger comprises the plurality of pins, the plurality of pins aligned and oriented such that each of the plurality of pins is received within the aperture of a corresponding hollow pin of the plurality of hollow pins.

Example 51. The method of example 30, further comprising: removably securing a cap onto the carrier such that the dried reagent on the flexible membrane of each of the plurality of hollow pins is disposed within a corresponding cavity of a plurality of cavities formed in the cap. Example 52. The method of example 51, wherein the cap is snap fit to the carrier.

Example 53. The method of example 31, comprising removing the cap and rehydrating the dried reagent on the flexible membranes of each of the plurality of hollow pins.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

The terms “generally”, “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a carrier comprising a carrier body and a plurality of pins extending from the carrier body, the plurality of pins aligned and oriented to correspond to a plurality of wells in a well plate and each of the plurality of pins having an end surface, opposite the carrier body; and
a dried reagent retained on the end surface of at least one of the plurality of pins.

2. The apparatus of claim 1, wherein the pins are generally cylindrical.

3. The apparatus of claim 1, wherein the end surfaces of the pins are planar surfaces.

4. The apparatus of claim 1, wherein the end surfaces of the pins have a concave surface.

5. The apparatus of claim 1, wherein the end surfaces of the pins have a first slot extending radially across the end surface.

6. The apparatus of claim 5, wherein the end surfaces of the pins have a second slot extending radially across the end surface, generally perpendicular to the first slot.

7. The apparatus of claim 1, wherein the end surfaces of the pins comprise outwardly extending cups, each cup having a corresponding concave cavity.

8. The apparatus of claim 1, including a cap comprising a cap body and a plurality of covers extending from the cap body, each of the plurality of covers including a cavity configured to receive a corresponding pin of the carrier.

9. The apparatus of claim 8, wherein the plurality of covers are snap fit to the plurality of pins.

10. The apparatus of claim 8, wherein the cap comprises a plurality of key features extending from the cap body, opposite the covers, each of the plurality of key feature being configured to be engaged by a cap removal system.

11. The apparatus of claim 10, wherein each of the plurality of key features comprises a shaft and a head at an end of the shaft, the head having a larger diameter than the shaft.

12. The apparatus of claim 1, including a cap, the cap comprising: a cap body; a plurality of covers extending from the cap body, each of the plurality of covers comprising an aperture that extends through the cover and the cap body and is configured to receive a corresponding pin of the carrier; and at least one pierceable membrane secured to the cap body and sealing at least a portion of the apertures.

13. The apparatus of claim 12, wherein each of the plurality of pins includes a membrane piercing member extending from the end surface.

14. The apparatus of claim 1, wherein the plurality of pins comprise a first pin having a first reagent retained on the end surface of the first pin and a second pin having a second reagent, different than the first reagent, retained on the end surface of the second pin.

15. An apparatus, comprising:
a carrier comprising a carrier body and a plurality of hollow pins extending from the carrier body, the plurality of hollow pins aligned and oriented to correspond to a plurality of wells in a well plate and each of the plurality of hollow pins having an aperture that extends through the hollow pin and carrier body and a flexible membrane extending across an end of each hollow pin; and
a plunger comprising a plunger body and a plurality of pins extending from the plunger body, the plurality of pins aligned and oriented such that each of the plurality of pins is received within the aperture of a corresponding hollow pin of the plurality of hollow pins and each of the plurality of pins having an end surface, opposite the plunger body; and
a dried reagent retained on the flexible membrane of at least a portion of the plurality of hollow pins.

16. The apparatus of claim 15, wherein the pins are generally cylindrical.

17. The apparatus of claim 15, wherein the end surfaces of the pins have a protruding surface.

18. The apparatus of claim 15, including a cap, the cap comprising:
a cap body;
a plurality of covers extending from the cap body, each of the plurality of covers comprising an aperture that extends through the cover and the cap body and is configured to receive a corresponding hollow pin of the carrier; and
at least one pierceable membrane secured to the cap body and sealing at least a portion of the apertures.

19-38. (canceled)

39. A method, comprising:
extending a plurality of hollow pins through a pierceable membrane of a cap and into a plurality of well in a well plate, where a carrier comprises the plurality of pins and a dried reagent is retained on a flexible membrane secured to an end of at least one of the plurality of hollow pins, the plurality of hollow pins aligned and oriented to correspond to the plurality of wells in the well plate;
extending a plurality of pins through the plurality of hollow pins of the carrier to deform the flexible membrane and push the dried reagents out of the plurality of hollow pins, where a plunger comprises the plurality of pins, the plurality of pins of the plunger aligned and oriented to correspond to the plurality of hollow pins of the carrier; and
rehydrating the dried reagent.

40. The method of claim 39, wherein
rehydrating the dried reagent comprises inserting the plurality of pins into the corresponding plurality of wells of the well plate, the plurality of wells having a liquid therein, and waiting a period of time.

41. The method of claim 40, further comprising agitating the plurality of pins within the plurality of wells for a period of time.

42. The method of claim 37, wherein rehydrating the dried reagent comprises inserting the plurality of pins into the corresponding plurality of wells of the well plate, dispensing a liquid into the plurality of wells, and waiting a period of time.

43-53. (canceled)
